(19) United States
(12) Patent Application Publication
(10) Pub. No.: US 2004/0055138 A1
(43) Pub. Date: Mar. 25, 2004

(54) Generator rotor jacking assembly and methods of use

(76) Inventors: Andrew John Tomko, Glenville, NY (US); Brian Patrick Marks, Glenville, NY (US); James Alan Gradie, Oakland, ME (US)

Correspondence Address: NIXON & VANDERHYE P.C., 8th Floor, 1100 North Glebe Rd., Arlington, VA, 22201-4714, US

(21) Appl. No.: 10/246,621

(22) Filed: Sep. 19, 2002

(51) Int. Cl. H02K 15/00

(52) U.S. Cl. 29/596

(57) ABSTRACT

A generator rotor jacking assembly includes a saddle secured to a generator end shield in the place of an outer oil deflector removed from the end shield. A yoke is located above the saddle and underlies the rotor end. Fluid-actuated cylinders are interposed between anvils on the saddle and flanges on the yoke to elevate the rotor end from the bearing, relieving the bearing from the weight of the rotor. A sling is then disposed about the rotor to support the rotor in an elevated position. The lower end shield is then lowered, carrying with it the associated parts for repair and maintenance.

### BACKGROUND OF THE INVENTION

The present invention relates generally to the assembly and disassembly of generator rotors using a jacking assembly and particularly relates to a rotor jacking assembly for and methods of fluidically jacking an end of the rotor to relieve the weight of a rotor end on an associated rotor end bearing.

In electrical generators, the generator field or rotor must be positioned vis-a-vis the stator frame to enable removal or assembly of the lower bearing, seals, outer and inner oil deflectors, and other ancillary equipment. It will be appreciated that during disassembly of a generator, the rotor must be supported, at least at one end, by other than the rotor support bearing to enable removal of the lower halves of the bearing, hydrogen seal and inner oil deflector. Similarly, upon assembly of the rotor, ancillary support for the rotor must be provided in order to install the inner oil deflector, hydrogen seal and bearing. Currently, jack bolts installed on a yoke are used to raise and lower a rotor end relative to its end bearing. Particularly, a saddle is secured to the stator end shield. Jack bolts are screwthreaded through the yoke and engage at their lower ends on anvils or flanges of the saddle. The yoke, of course, underlies and bears the weight of the rotor end and places a significant point load on each of the jack bolts. This results in large friction forces which are difficult to overcome.

More particularly, large impact wrenches, together with torque multipliers, are oftentimes required to rotate the jack bolts to displace the rotor end relative to the saddle. This is labor-intensive and of such difficulty that in certain situations, a crane must be utilized to elevate the rotor, removing the weight from the yoke in order to free the bolts to displace the yoke upwardly relative to the saddle. While the use of a crane enables the jack bolts to be more readily turned and hence elevate the yoke to a location to support the rotor end off the end bearing, use of a crane is an additional, laborious, expensive and time-consuming task.

### BRIEF DESCRIPTION OF THE INVENTION

In accordance with a preferred embodiment of the present invention, there is, provided apparatus and methods for fluidically elevating at least one end of the rotor from its end support bearing, i.e., to relieve the bearing from the weight of the rotor. To accomplish that, a saddle is secured to the end shield and has anvils located on opposite sides of the rotor. A yoke is disposed above the saddle and underlies the rotor end. The yoke includes laterally projecting flanges in vertical registration with the anvils on the opposite sides of the rotor. Fluid-actuated cylinders are coupled to the flanges and anvils such that the yoke, together with the rotor end, can be elevated relative to the saddle upon actuation of the cylinders to relieve the weight of at least one end of the rotor from the corresponding end rotor support bearing. The cylinders are preferably hydraulic and located between the flanges and anvils of the yoke and saddle, respectively. As a result, the rotor end may be displaced vertically up or down within the stator frame without the use of jack bolts or a crane. Additionally, the typically large holes that are required to be drilled in the yoke for the jacking bolts and the wear and tear on tools associated with efforts to rotate the oftentimes stuck jacking bolts, i.e., large impact wrenches and torque multipliers, are eliminated. The present process is thus less labor-intensive and safer in comparison with the previously discussed prior process.

In a preferred embodiment according to the present invention, there is provided a method of displacing a rotor in a generator for unloading the weight of the rotor from a rotor bearing, comprising the steps of (a) supporting a pair of anvils along opposite sides of the rotor adjacent the rotor bearing, (b) disposing a yoke about an underside of the rotor with a pair of flanges along opposite sides of the yoke in substantial vertical alignment with the respective anvils, (c) providing fluid-actuated cylinders to the anvils and flanges on opposite sides of the rotor and (d) actuating the cylinders to displace the yoke and rotor in an upward direction away from the anvils thereby relieving the rotor bearing of at least a portion of the weight of the rotor.

In a further preferred embodiment according to the present invention, there is provided a method of displacing a rotor in a generator for unloading the weight of the rotor from a rotor bearing, comprising the steps of (a) securing a saddle to an end shield of the generator locating a pair of anvils carried by the saddle along opposite sides of the rotor, (b) disposing a yoke about an underside of the rotor with a pair of flanges along opposite sides of the yoke in substantial vertical alignment with the respective anvils on the saddle, (c) providing fluid cylinders to the anvils and flanges on opposite sides of the rotor and (d) actuating the cylinders to displace the yoke and rotor in an upward direction away from the saddle thereby relieving the rotor bearing of at least a portion of the weight of the rotor.

In a further preferred embodiment according to the present invention, there is provided a generator comprising a housing having end shields and bearings adjacent opposite ends, a rotor within the housing and carried by the bearings, an anvil secured to one of the end shields adjacent one end of the housing, a yoke disposed above the anvil and underlying an end portion of the rotor adjacent the one housing end and a pair of fluid-actuated cylinders coupled to the anvil and the yoke for elevating the rotor end portion from the bearing adjacent the one housing end in response to actuation of the cylinders.

### BRIEF DESCRIPTION OF THE DRAWINGS

FIG. 1 is a schematic cross-sectional view through a centerline of a generator;

FIG. 2 is an enlarged cross-sectional view of a portion of an end shield at one end of the generator housing with a jacking assembly of the prior art attached to the end shield;

FIG. 3 is a view similar to FIG. 2 illustrating a jacking assembly according to a preferred embodiment of the present invention secured to the end shield;

FIG. 4 is an enlarged end elevational view of a saddle and yoke forming a portion of the jacking assembly of the present invention;

FIG. 5 is a perspective view illustrating a support device for the rotor end; and

FIG. 6 is an end view of the generator with the rotor supported by the support device of FIG. 5 and the end shield in a lowered position.

### DETAILED DESCRIPTION OF THE INVENTION

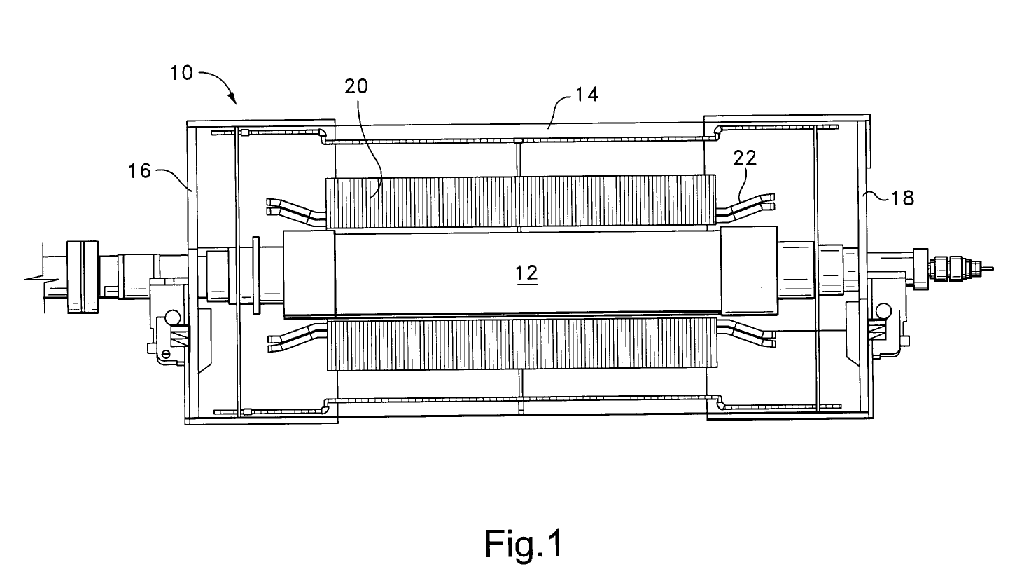

Referring now to the drawings, particularly to FIG. 1, there is illustrated a generator, generally designated 10, having a rotor or field 12 disposed in a generator housing 14 including end shields 16 and 18 at the turbine and collector ends of the generator, respectively. The stator punchings 20 and end bars 22 are also illustrated about the field 12.

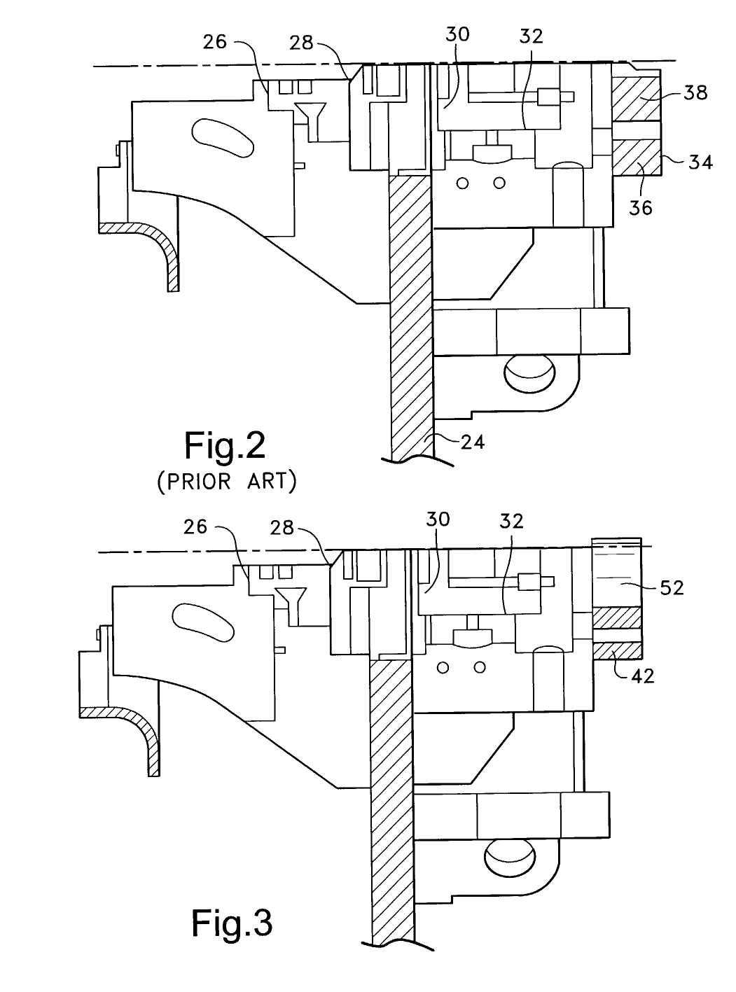

As best illustrated in FIG. 2, the lower end shield 24 at the collector end shield 18 includes an inner oil deflector 26, a hydrogen seal casing 28, a bearing 30, a bearing ring 32 and, in this instance, a prior art shaft jacking device 34 which has been secured in place of an outer oil deflector, not shown. It will be appreciated that the rotor 12 rests on the bearing 30 during normal usage and that the rotor, at least at one end, must be elevated to relieve the weight of the rotor end from the bearing to remove the lower half of the bearing and gain access to the hydrogen seal casing and inner oil deflector for repair or replacement.

As indicated previously, the prior jacking assembly 34 includes a saddle 36 secured to the lower end shield 24 and a yoke 38 underlying the rotor. With the jacking device assembled to the end shield, jack bolts, not shown, interconnecting the yoke 38 and saddle 36 are rotated to elevate the yoke relative to the saddle to lift the rotor end from the bearing thereby relieving the bearing of the weight of the rotor at one end of the generator.

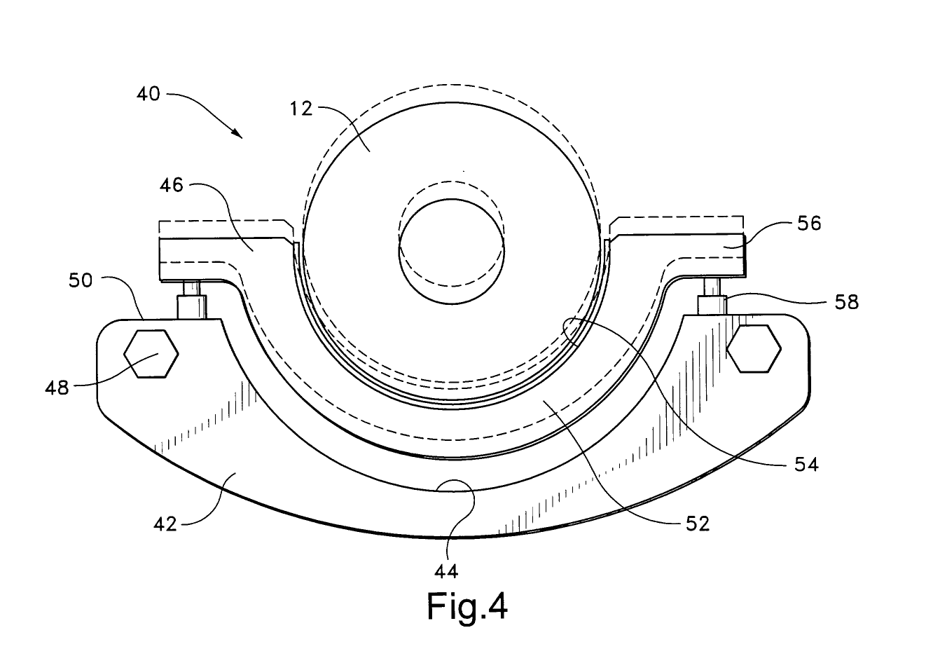

In accordance with the present invention and referring particularly to FIG. 4, a jacking assembly according to the present invention is generally indicated 40. Jacking assembly 40 includes a lower saddle 42 having an enlarged concave recess 44 along its upper side for receiving a corresponding generally semi-cylindrical portion of a yoke 46. The saddle 42 is secured to the lower end shield 24 by bolts 48 subsequent to removal of the outer oil deflector, not shown. Opposite sides of the saddle 42 have upwardly facing surfaces or anvils 50 which straddle the yoke 46 as well as the end of the rotor 12.

The yoke 46 includes a generally semi-cylindrical section 52 having a padded concave recess 54 for engaging about the lower half of an end of the rotor 12. Opposite sides of the yoke 46 are provided with flanges 56. The arcuate recess 54 extends beyond the horizontal diameter of the rotor, i.e., the upper surfaces of flanges 56 lie above a horizontal plane through the diameter of the rotor when the rotor is to be elevated. A pair of fluid-actuated, preferably hydraulic cylinders are connected between the flanges 56 of yoke 46 and the anvils 50 of saddle 42. While the cylinders and pistons of the fluid-actuated cylinders can be located on opposite sides of the flanges 56, the cylinders and pistons are preferably disposed between the flanges 56 and anvils 50. The preferred hydraulic cylinders 58 may be of the type manufactured by Enerpac, Milwaukee, Wis. In FIG. 4, the solid line represents the position of the saddle and yoke, with the fluid cylinders in a retracted position and the rotor 12 resting on the bearing 30. The dashed line configuration in FIG. 4 illustrates the position of the yoke and the rotor upon actuation of fluid cylinders 58 to displace one end of the rotor from an end bearing 30 thereby relieving the weight of the rotor end on the bearing.

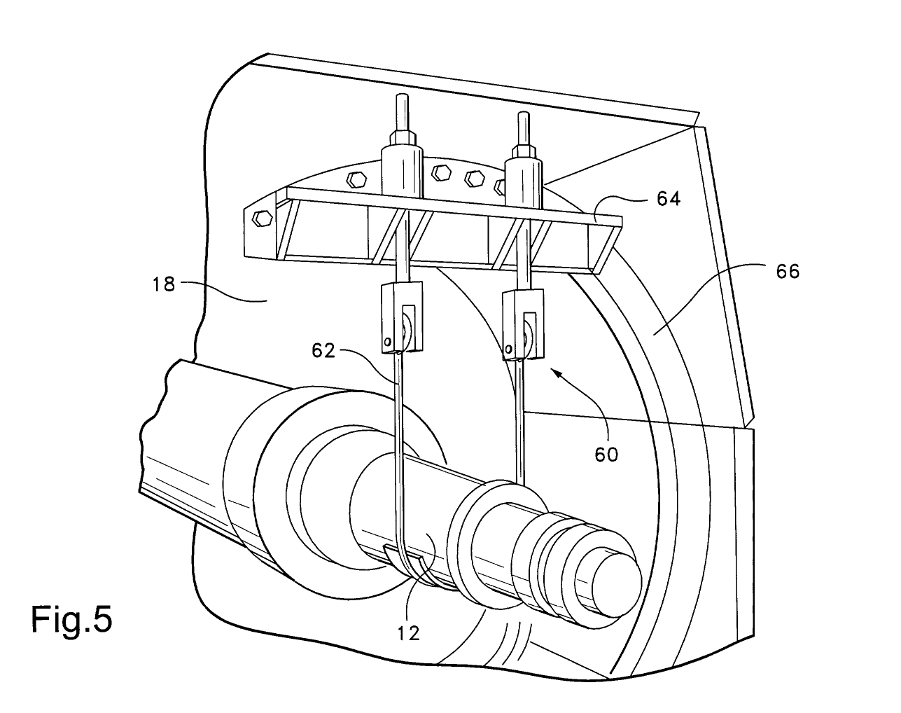

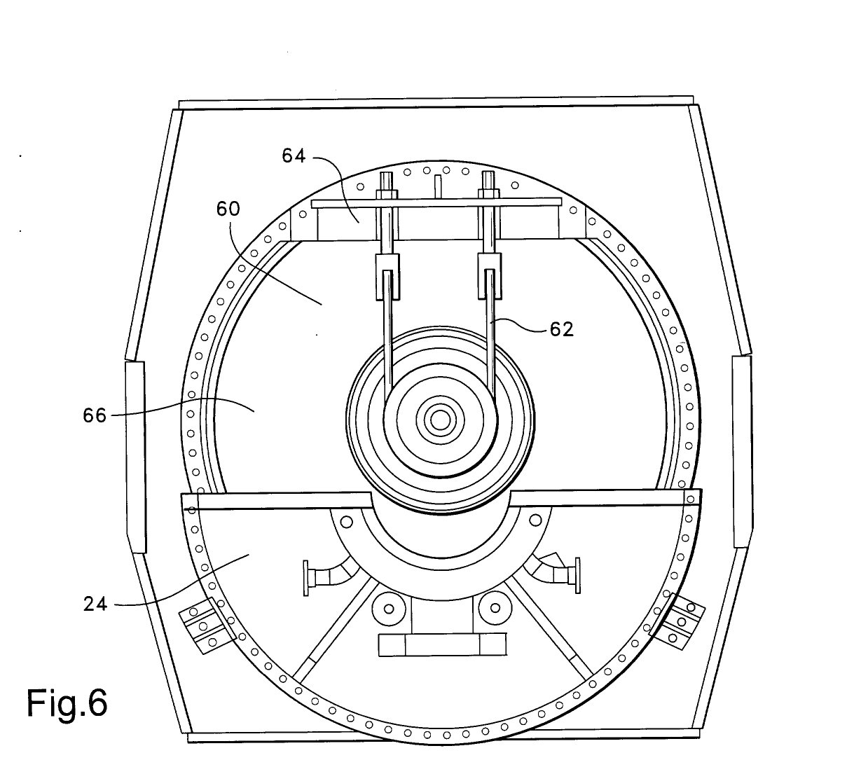

In FIGS. 5 and 6, there is illustrated a support sling, generally indicated 60, for supporting the end of the rotor when the various ancillary parts of the end shield are removed for maintenance and repair as well as when the bearing has been removed. The sling 60 includes a flexible strap 62 which engages the underside of the rotor 12 to support the latter during maintenance and repair. The sling 60 may be mounted on support bracing 64 mounted to and along the upper portion 66 of end shield 18.

In order to service the bearing, oil deflectors and ancillary parts, the outer oil deflector, not shown, is first removed from the end shield 18, for example, at the collector end of the generator. In its place, the saddle 42 is secured by bolts 48 to the lower end shield 24. The yoke 52 is located below the rotor 12 with the flanges 46 resting on the fluid cylinders 58. With the yoke and saddle in place and the weight of the rotor on the bearing, the fluid cylinders 58 are actuated. Upon actuation, the cylinders elevate the yoke and consequently the end of the rotor to raise the rotor end off the bearing by a small distance, for example, 0.005 inch. With the weight of the rotor transferred to the lower end shield 24 and off the bearing 30, the lower bearing is removed. The sling 60 is then disposed about the rotor 12 to support the rotor in its elevated position. With the weight of the rotor off the bearing, the lower end shield, including the yoke and saddle, is lowered, as illustrated in FIG. 6, to a position enabling ready access to the oil deflector, hydrogen casing seal and other ancillary parts for service and repair.

It will be appreciated that the reverse procedure can be used to reinstall the various parts carried by the end shield for supporting the generator rotor. Thus, after service and maintenance has been performed, and the various serviced or replaced parts are in place, i.e., the bearing, inner oil deflector and hydrogen seal casing, the lower end shield 24 is raised. The yoke is thus reengaged in its hydraulically extended position with the rotor end. The sling 60 is then removed to transfer the weight of the rotor end onto the yoke and saddle. With the bearing in place, the hydraulic cylinders are retracted, lowering the rotor end onto the bearing. With the weight transferred to the bearing, the yoke and saddle are removed and the outer oil deflector is secured to the end shield.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of displacing a rotor in a generator for unloading the weight of the rotor from a rotor bearing, comprising the steps of:
(a) supporting a pair of anvils along opposite sides of the rotor adjacent the rotor bearing;
(b) disposing a yoke about an underside of the rotor with a pair of flanges along opposite sides of the yoke in substantial vertical alignment with the respective anvils;
(c) providing fluid-actuated cylinders to the anvils and flanges on opposite sides of the rotor; and
(d) actuating the cylinders to displace the yoke and rotor in an upward direction away from the anvils thereby relieving the rotor bearing of at least a portion of the weight of the rotor.

2. A method according to claim 1 including disposing the cylinders between the anvils and flanges.

3. A method according to claim 1 including supporting the rotor displaced in accordance with step (d) and removing the bearing from the generator.

4. A method of displacing a rotor in a generator for unloading the weight of the rotor from a rotor bearing, comprising the steps of:
(a) securing a saddle to an end shield of the generator locating a pair of anvils carried by the saddle along opposite sides of the rotor;
(b) disposing a yoke about an underside of the rotor with a pair of flanges along opposite sides of the yoke in substantial vertical alignment with the respective anvils on the saddle;
(c) providing fluid cylinders to the anvils and flanges on opposite sides of the rotor; and
(d) actuating the cylinders to displace the yoke and rotor in an upward direction away from the saddle thereby relieving the rotor bearing of at least a portion of the weight of the rotor.

5. A method according to claim 4 including disposing the cylinders between the anvils and flanges.

6. A method according to claim 4 including, prior to step (a), removing an oil deflector located adjacent said end shield and securing said saddle to said end shield in said location of the removed oil deflector.

7. A generator comprising:
a housing having end shields and bearings adjacent opposite ends;
a rotor within said housing and carried by said bearings;
an anvil secured to one of said end shields adjacent one end of the housing;
a yoke disposed above said anvil and underlying an end portion of the rotor adjacent said one housing end; and
a pair of fluid-actuated cylinders coupled to said anvil and said yoke for elevating said rotor end portion from the bearing adjacent said one housing end in response to actuation of the cylinders.

8. A generator according to claim 7 wherein said cylinders are mounted between said anvil and said yoke.

9. A generator according to claim 8 wherein said cylinders comprise hydraulic cylinders.
